(19) United States
(12) Patent Application Publication
(10) Pub. No.: US 2007/0288452 A1
(43) Pub. Date: Dec. 13, 2007

(54) System and Method for Rapidly Searching a Database

(75) Inventor: Christine Podilchuk, Warren, NJ (US)

Correspondence Address: CATALINA & ASSOCIATES;A Professional Corporation, 2355 HIghway 33, Robbinsville, NJ, 08691, US

(73) Assignee: D&S CONSULTANTS, INC., Eatontown, NJ (US)

(21) Appl. No.: 11/619,104

(22) Filed: Jan. 2, 2007

Related U.S. Application Data
(60) Provisional application No. 60/812,646, filed on Jun. 12, 2006.
(60) Provisional application No. 60/816,686, filed on Jun. 27, 2006.
(60) Provisional application No. 60/861,685, filed on Nov. 29, 2006.
(60) Provisional application No. 60/861,932, filed on Nov. 30, 2006.
(60) Provisional application No. 60/873,179, filed on Dec. 6, 2006.

(51) Int. Cl. G06F 17/30

(52) U.S. Cl. 707/5

(57) ABSTRACT

A system and method for rapidly searching large databases. A database is transformed into a similarity matrix using a similarity metric, such as an edit distance. A query object is compared to one member of the database using the same similarity metric, resulting in a similarity score. The row of the similarity matrix corresponding to the selected member is examined to find a best match similarity score. If the best match relates the selected member to itself, then the query object is identified as being the selected member, as long as it is above a threshold. If, not, the process is repeated using the other member of the database referred to by the best match. The process is repeated until the process converges, i.e. until the best match to the similarity score of the query object and the reference object is the element relating the reference object to itself.

### CROSS REFERENCE TO RELATED APPLICATIONS

This application is related to, and claims priority from, U.S. Provisional Patent application No. 60/873,179 filed on Dec. 6, 2006 by C. Podilchuk entitled “Fast search paradigm of large databases using similarity or distance measures”, the contents of which are hereby incorporated by reference.

### FIELD OF THE INVENTION

The present invention relates to systems and methods for rapidly searching large databases, and more particularly, to systems and methods for identifying objects by rapidly searching large databases using pre-computed similarity matrices.

### BACKGROUND OF THE INVENTION

A common approach to the task of identifying, or classifying, an unknown object is to compare the unknown object to a set of reference objects. The unknown object may then be identified as being the member of the reference set to which it appears most similar, as long as that similarity is above a predetermined threshold.

In order to use computers for identification using this approach, it is typical to have a reference database and a method of comparing a digital representation of an object to be identified to the members of the reference database. The method of comparing the digital representations, sometimes referred to as the comparison metric, may be an absolute metric or a relative metric.

An absolute metric is one that uses attributes of an object, or the digital representation of the object, to arrive at a unique number, or vector, for that object. The reference database may then be a collection of the unique numbers, or vectors, for the set of reference objects. Such an identification method is described in, for instance, U.S. Pat. No. 4,901,362 issued to Terzian on Feb. 13, 1990 entitled “Method of recognizing patterns”, the contents of which are hereby incorporated by reference. Using an absolute metric has the advantage that searching the database is reasonably efficient. Absolute metrics, however, have the disadvantage of being limited to use in situations where the attributes of the object are precisely determined, readily enumerated and vary sufficiently in a way that allows a unique identifier can be determined. Situations where they are useful include, for instance, identification using the features of a fingerprint.

A relative metric is one that measures the similarity of one object to another object. The result of applying such a metric is typically expressed as a distance between the objects, rather than an absolute number identifying the objects. Relative, or similarity, metrics, however, do provide a powerful way of dealing with objects that have attributes that are difficult to define or enumerate or do not vary in a way that allows a unique identifier to be determined reliably. One such similarity metric is the well-known minimum edit distance that is widely used in, for instance, biometric identification, text and speech recognition, video search and DNA sequence matching. An identification system using such a similarity metric is described in, for instance, published US Patent Application 20050129290 submitted by Lo et al. and published on Jun. 16, 2005 entitled “Method and apparatus for enrollment and authentication of biometric images” the contents of which are hereby incorporated by reference.

A disadvantage of identification systems that use similarity metrics is that they tend be computationally expensive, particularly if the similarity metric itself requires any appreciable amount of computing power. This computational expense is the result of having to search the entire reference database by comparing the unknown object with each member of the reference set. Each comparison typically requires performing the similarity metric on the unknown object and a member of the reference set. Unless the similarity metric is very computationally efficient, the total amount of effort to search a large database can be prohibitive.

A system and method that enables rapid and efficient searches of large databases to identify unknown objects on the basis of similarity metrics, irrespective of the computational efficiency of the similarity metric, would be of considerable use in the fields of biometrics, text and speech recognition, image matching and video surveillance.

### SUMMARY OF THE INVENTION

Briefly described, the present invention provides a system and method for rapidly searching large databases using similarity metrics so that a query object may be rapidly identified as being most similar to one of the members of the database, as long as that similarity is above-a predetermined threshold.

The system and method of this invention includes the use of a similarity matrix, i.e. a matrix of scores which express the similarity between two data points.

In a preferred embodiment of the present invention, a reference database is first transformed into a similarity matrix, i.e., a matrix of similarity measures that relate each member of the database to itself or to another member of the reference database. The similarity metric selected to generate the similarity matrix may be, but is not limited to, the well-known Levenshtein distance, the Euclidean distance, or the well-known Needleman and Wunsch algorithms. In a further preferred embodiment, the selected similarity metric may be the image edit distance, a metric described in detail in related U.S. patent application Ser. No. 11/619,092 filed on Jan. 2, 2007 by Podilchuk entitled “System and Method for Comparing Images using an Edit Distance”, filed on even date and which is hereby incorporated by reference.

Having generated a pre-computed similarity matrix, the database may then be rapidly and efficiently searched in the following manner.

A digital representation of a query object may be compared to one member of the reference database using the same similarity metric used to construct the similarity matrix, resulting in a similarity score between the query object and the selected member of the reference database. The row of the similarity matrix corresponding to the selected member may then be examined to find a similarity score that is closest to the one just obtained between the query object and the reference object. If the element that is the closest match relates the selected member to itself, then the query object is identified as being the selected member, as long as the similarity is above a predetermined threshold.

If, however, the element relates the selected member to another member of the database, then a new similarity score is calculated between the query object and the other member of the database to which the element referred. As before, the row of the similarity matrix corresponding to the other member of the database is then examined to find a closest match to the new similarity score. If the closest match is the other member itself, then it is identified as the query object, as long as the similarity is above a predetermined threshold. If the closest match does not reference itself, another iteration of the process is undertaken, i.e., new similarity score is calculated with the next member of the database referenced by the closest match element, and its corresponding row in the similarity matrix examined. These iterations continue until the query object is identified, i.e. until the closest match to the similarity score of the query object and the reference object is the element relating the reference object to itself.

The method of this invention has the advantage of, for a database of M member, only requiring generating, on average, log₂(M) similarity scores rather than the M scores needed by convention methods.

Because the similarity matrix is symmetrical, i.e. S(i,j)=S(j,i), the steps described above could also be described with respect to inspecting the corresponding columns of the similarity matrix, or by alternating between row and column or some suitable combination thereof. Moreover, only half of each row or column needs to be compared and sorted to the current score to find the closest match.

These and other features of the invention will be more fully understood by references to the following drawings.

### BRIEF DESCRIPTION OF THE DRAWINGS

FIG. 1 is schematic representation of an exemplary embodiment of an identification system utilizing the present invention.

FIG. 2 is a schematic representation of an exemplary similarity matrix.

FIG. 3 is a flow chart showing steps in searching a database using a pre-computed similarity matrix.

FIG. 4 is a schematic representation of an object classification hierarchy.

### DETAILED DESCRIPTION

The present invention applies to systems and methods for rapidly searching a large database using similarity metrics. The system and method uses a pre-computed similarity matrix that relates each member of a reference set to each other by a similarity metric. The pre-computed similarity matrix may be used to rapidly identify a query object as being most similar to one member of the database.

The system and method of the present invention may be used in a variety of applications that utilize scores between signals stored in a gallery or database. For instance, the method may be applied to identification problems using scores that, for instance, represent a similarity measure between two signals. Such a measure of similarity may also be referred to as a similarity measure or metric, a distance metric, an edit distance, a string-to-string correction, or a substitution matrix. Many different algorithms have been developed to derive good similarity metrics for different types of signals. Common techniques for computing similarity or distance metrics include, but are not limited to, the Levenshtein distance, the Euclidean distance, the Needleman and Wunsch algorithms for finding similarities in amino acid sequences of two proteins, dynamic time warping using dynamic programming for one-dimensional temporal sequences such as speech segments and probabilistic measures such as those based on Markov Models. The applications that utilize such scores may include, but are not limited to, biometric identification, text and speech recognition, image and video search and identification of objects of interest in video surveillance.

The system and method of the present invention may also be applied to many applications that require identifying an unknown query or probe signal with a database of more than one gallery or database signal. The signal may, for instance, be a one or multi-dimensional digital representation of an input signal such as, but not limited to, a fingerprint, a face, a target, an object of interest, a speech sample, an iris or palm print, a DNA sequence, or a text sequence. The fast search technique of the present invention may also be useful for applications in biometric identification for logical and physical access control and surveillance, bioinformatics, and text recognition among others.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

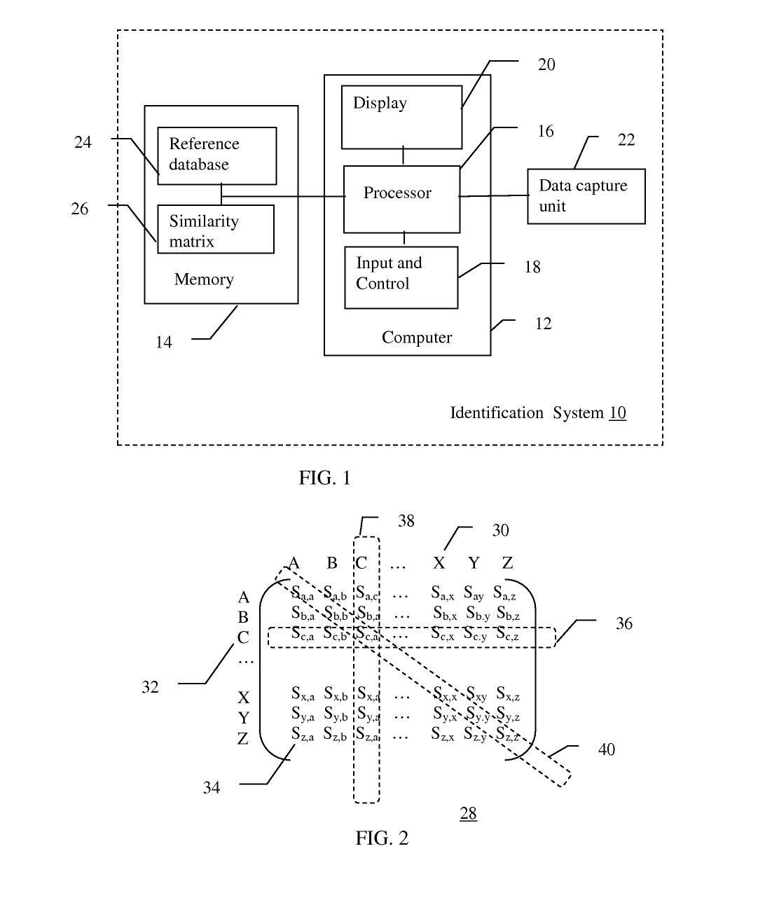

FIG. 1 is schematic representation of an exemplary embodiment of an identification system 10 of the present invention. The identification system 10 may include a computer 12, a memory unit 14 and a suitable data capture unit 22.

The computer 12 may, for instance, be a typical digital computer that includes a central processor 16, an input and control unit 18 and a display unit 20. The central processor 16 may, for instance, be a well-known microprocessor such as, but not limited to, a Pentium™ microprocessor chip manufactured by Intel Inc. of Santa Clara, Calif. The input and control unit 18 may, for instance, be a keyboard, a mouse, a track-ball or a touch pad or screen, or some other well-known computer peripheral device or some combination thereof. The display unit 20 may, for instance, be a video display monitor, a printer or a projector or some other well-known computer peripheral device or some combination thereof. The central processor 16 may be connected to a suitable data capture unit 22 that for identification purposes may, for instance, be a still or video camera that may be analogue or digital and may, for instance, be a color, infra-red, ultra-violet or black and white camera or some combination thereof. The data capture unit 22 may also, or instead, be a scanner or a fax machine. The central processor 16 may have an internal data storage and may also be connected to an external memory unit 14 that may, for instance, be a hard drive, a tape drive, a magnetic storage volume or an optical storage volume or some combination thereof. The memory unit 14 may store both a reference database 24 and a similarity matrix 26.

The identification system 10 operates by first obtaining a reference database 24. This reference database 24 may, for instance, be a set of digital representations of objects to be recognized such as, but not limited to, a set of digital images of faces, cars, weapons, people or vehicles. The reference database 24 may be downloaded from another source or captured, in whole or in part, using the data capture unit 22 under the control of the central processor 16. Prior to use in identification, the reference database 24 may be converted to a similarity matrix 26 using appropriate software packages running on the computer 12.

FIG. 2 is a schematic representation of an exemplary similarity matrix 28. The similarity matrix 28 may be a symmetric square matrix in which the matrix columns 30 and the matrix rows 32 both represent the members of the reference database 24. In FIG. 2, the members of the reference database 24 are represented by the letters A . . . Z. The matrix elements 34 represent the similarity of the members of the reference database 24 to each other, and to themselves. In FIG. 2, the matrix elements 34 have the form Si,j with S indicating that it is a similarity and the i referencing the matrix rows 32 and the j referencing the matrix columns 30. The matrix elements 34 are computed using a selected similarity metric. The selected similarity metric may be, but is not limited to, the well-known Levenshtein or edit distance, the Euclidean distance, the well-known Needleman and Wunsch algorithms or the image edit distance.

To identify an unknown, or query object, the identification system 10 first obtains a digital representation of a query object. This may, for instance, be accomplished using the data capture unit 22 under the control of the computer 12, or the digital representation may be acquired via the input and control unit 18.

The identification system 10 then obtains a first similarity measure of the query object to a first member of the reference database 24 using the same similarity metric used to construct the similarity matrix 28. This first member of the reference database 24 may be selected randomly, or according to a suitable algorithm, by suitable software running on the central processor 16 or it may be selected by an operator using the input and control unit 18. The software running on the central processor 16 then examines the corresponding row 36 of the similarity matrix 28 looking for the matrix element 34 that has a similarity score that is closest to the one just obtained between the query object and the first reference object. If the matrix elements 34 that contains the closest match relates the selected member to itself, i.e., it is of the form Si,i and lies on the matrix diagonal 40, then the query object is identified as being the selected member of the reference database, i.e., the member referenced by i.

If, however, the matrix elements 34 that contains the closest match relates the selected member to another member of the database, i.e., it is of the form Si,j and does not lie on the matrix diagonal 40, then a new similarity score is calculated between the query object and the other member of the database to which the matrix elements 34 referred, in this case, the reference object referenced by j. As before, the row of the similarity matrix corresponding to the other member of the database is then examined to find a closest match to the new similarity score. If the closest match is the other member itself, then it is identified as being the query object, as long as the similarity is above a predetermined threshold. If the closest match is not the reference object referencing itself, another iteration of the process is undertaken, i.e., new similarity score is calculated with the next member of the database referenced, and its corresponding row in the similarity matrix examined. These iterations continue until the best match to the query object is identified, i.e. until the closest match to the similarity score of the query object and the reference object is the element relating the reference object to itself.

As one of ordinary skill in the art will appreciate, there may be more than one entry in a similarity matrix representing a given object. As detailed above, if there is only one unique entry for each object to be identified, then the fast search stops when the best match occurs along the diagonal (i=j). If, however, there are a number of entries for each object to be identified, and the entries for each object are clustered together as adjacent rows and columns, then the search may stop when the best match is in the N×N square centered on the diagonal where N is the number of entries for each object. This number N may be one or more and may be different for each object in a given reference set.

One of ordinary skill in the art will also readily appreciate that the similarity matrix does not need to have all scores entered in order to be able to use this fast search approach. The missing entries may, for instance, simply be ignored in the search or they may be interpolated from the existing scores.

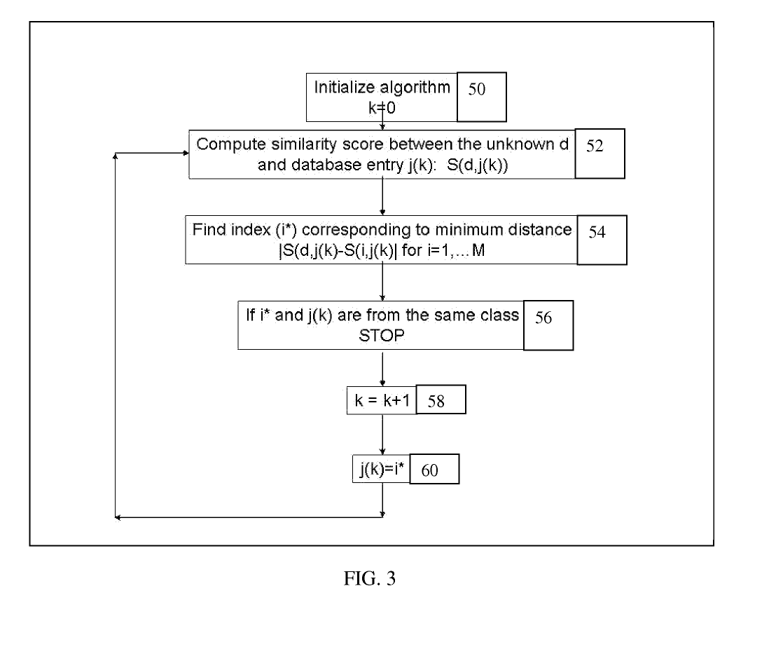

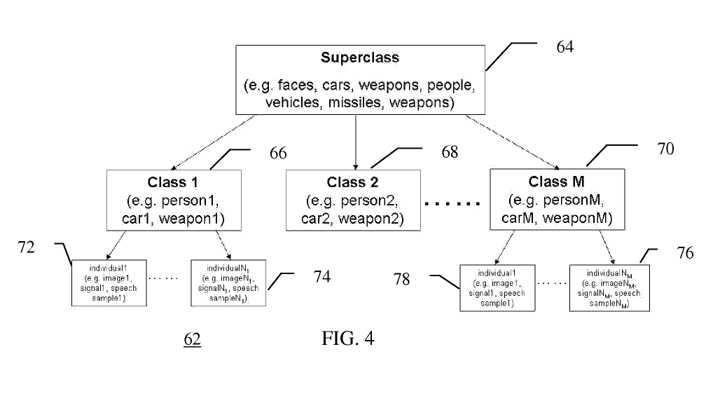

FIG. 3 is a flow chart showing steps in searching a database using a pre-computed similarity matrix.

As before, S represents the two-dimensional array, or similarity matrix 28, of pre-computed similarity, or distance, metrics between every pair of signals, or a subset of signals, in the reference database 24. M represents the number of prestored files in the database. Each matrix element 34, or entry S(i,j), represents the similarity score between the ith and jth entry. Since the similarity between the ith and jth element is the same as the similarity between the jth and ith element, the matrix is symmetric.

The symbol d represents the unknown probe signal to be identified. An exhaustive search approach requires computing the similarity score between d and all M entries in the database and then choosing the largest score and comparing it to a threshold. In a preferred embodiment of the invention, such an exhaustive search is avoided.

In a preferred embodiment of the present invention, in step 50 a suitable software program running on, for instance, a central processor 16 is initialized by choosing one of the M database entries of the reference database 24 and computing the score between the unknown signal d and the chosen entry. This initialization can be done randomly or by using a fast distance measure between d and all of the database entries. Examples of fast distance measures include the Euclidean or L1 metric between the two signals.

In step 52, the similarity score between the unknown signal d and the chosen reference database 24 entry j(t) at t=0 is computed as S(d,j(0)).

In step 54, the computed similarity score is compared to the matrix elements 34 of the row corresponding to the chosen member of the reference database 24, i.e., to all of the entries for S(i,j(0)) i=1,2 . . . M. The matrix element 34 is chosen that minimizes the distance |S(d,j(0))−S(i,j(0))| and is denoted as i*.

In step 56, the software running on the central processor 16 checks to see if the program has converged, i.e., to see if i* and j(k) are the same, or from the same class. If they are, the program stops and the unknown signal is identified as being i* or as being of the same class as i*.

If the program has not converged, the software running on the central processor 16 proceeds to step 58 and sets up for another round of iteration.

The program then proceeds to step 60, setting the chosen member of the database to now be i*. The software running on the central processor 16 then repeats steps 52, 54 and 56, i.e., the similarity score is then computed between d and entry j(1) as S(d,j(1)) and the above operations are repeated until the algorithm converges, i.e., j(i+1) corresponds to the same class as j(i).

The program also checks to see that the process has not become stuck in a local minimum where the search revisits two or more candidates in the similarity matrix in an infinite loop. In order to avoid this problem, the program in step 56 keeps a list of candidates and uses it to ensure that the program does not revisit any candidate that has already searched. Instead, if a previously used match is detected at step 56, the program goes on to the next best match that it has not previously visited.

The method's speed depends on the starting point but on average it reduces M computations to less than log₂(M).

The method is not, however, guaranteed to converge in less than M steps. In a preferred mode of operation the search continues until the method converges to a diagonal entry or all M similarity scores have been performed. If the method does run to calculating all M similarity scored before picking the best score, it has essentially defaulted to an exhaustive search technique.

In a further preferred embodiment, however, a stop criteria is a applied to limit the number of iterations the search makes. The stop criteria may be determined in a number of ways. The system may, for instance, stop the search after a predetermined number of iterations and use the best score or best matched score discovered up to that point. They system may, for instance, stop the stop the search if the matched scores, or normalized matched scores, at a particular iteration k are further apart than the matched scores, or normalized matched scores, at an immediately preceding iteration k−1. Or the system may stop the search if the scores at a current iteration k are smaller than the scores at an immediately preceding iteration k−1.

When the search is stopped by one of the preceding methods, the system may then use the current match. The system may, however, be programmed to select the best match among all candidates searched prior to stopping. The system may also be programmed to use a combination of scores based on multiple entries for each candidate. If the score arrived at by anyone of these methods is lower than a predetermined threshold, a decision may be made that the unknown probe is not represented in the current database.

Because the similarity matrix is symmetrical, i.e., S(i,j)=S(j,i), the steps described above could also be described with respect to inspecting the corresponding columns of the similarity matrix, or by alternating between row and column or some suitable combination thereof. Moreover, this symmetry means that only half of each row or column needs to be compared and sorted to the current score to find the closest match.

FIG. 4 is a schematic representation of an object classification hierarchy. The data model shown in FIG. 4 may, for instance, be considered as a data model as given by ontology in the field of computer science. Ontology typically consists of classes 66, 68 and 70 which are abstract sets, collections or types of objects. Attributes may be defined as properties or characteristics that objects have or share. Relations may be defined as the ways that the objects are related to each other. Individuals 72, 74. 78 and 76 may be considered as ground level objects. A class can consist of other classes. Such a class 64 may be referred to as a superclass consisting of subclasses in the parent child hierarchy.

A further application of the system and method of this invention relates to being given an input or probe signal designated as d(iₖᵢ) where i denotes the class and kᵢ denotes the individual instance of the class, and then trying to identify the input signal as belonging to one of the M classes.

Each class may, for instance, be defined by a set of attributes such as, but not limited to, the facial characteristics or fingerprints of a particular individual, car make or car model.

Let S(iₖᵢ,jₖⱼ) denote a similarity or distance metric between two signals denoted as iₖᵢ and jₖⱼ where i and j represent the class and kᵢ and kⱼ represents the individual sample from that class. The interclass relationships may then be defined as the similarity or distance metrics, S(iₖᵢ,jₖⱼ) when i is not equal to j and the intraclass relationships as the similarity or distance metrics S(iₖᵢ,jₖⱼ) when i is equal to j. One aspect of such an approach is that individuals belonging to the same class typically have more similar interclass and intraclass scores than individuals from different classes. The fast search strategy of the present invention may then make use of the following relationship:

|S(iₖ_{ᵢ},jₖ_{ⱼ})−S(xₖ_{ₓ},jₖ_{ⱼ})|≦|S(iₖ_{ᵢ},jₖ_{ⱼ})−S(yₖ_{_{y}},jₖ_{ⱼ})|

when i=x

and i≠y

The scores between instances within a class with a particular object denoted as jₖⱼ are typically more similar than the scores obtained between instances from different classes with the same object jₖⱼ. Pre-computed similarity scores may, therefore, be used to reduce the number of comparisons that are needed for an unknown probe signal using the above relationship in a wide range of applications, as already detailed in, for instance, FIG. 4.

In a further embodiment of the invention, the query objects may be used to update the similarity matrix 28. This may be accomplished by, for instance, using an M+1 dimensional vector corresponding to the scores of the unknown probe d with each of the original M database entries, as well as itself, that it was compared to during the search process. As the search is typically not exhaustive, the M+1 dimensional vector will only be populated for the entries that the fast search actually computed the similarity scores. This may be appended to the original M×M similarity matrix to produce an (M+1)×(M+1) matrix. The other scores may be left blank and ignored in future searches or they could be interpolated from the existed computed scores.

One of ordinary skill in the art will readily appreciate that since the similarity matrix is symmetric (i.e., S(i,j)=S(j,i)) finding the minimum difference between the pre-computed score and any column or row can be done on half the data (M/2).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed is:

1. A method of rapidly identifying a member of a database, said method comprising the steps of:
a) providing a similarity matrix comprised of a plurality of similarity measures each of which relates a member of said database to itself or to another member of said set of reference objects;
b) obtaining a first query similarity measure relating a query object to a first reference object;
c) examining a row of said similarity matrix corresponding to said first member of said database to obtain a row similarity measure closest to said first query similarity measure, and, if said row similarity measure relates said first database member to itself, identifying said query object as said first database member as long as said first query similarity is above a predetermined threshold, else obtaining a second query similarity measure relating said query object to a second database member that said row similarity measure relates to; and
d) repeating step c, appropriately incrementing said identifying numbers preceding said database members and said query similarity measures, until said row similarity measure relates said reference object to itself.

2. The method of claim 1 further comprising the steps of
e) after step c, examining a column of said similarity matrix corresponding to said second database member to obtain a column similarity measure closest to said second query similarity measure, and, if said column similarity measure relates said second database member to itself, identifying said query object as said second database member as long as said first query similarity is above a predetermined threshold, else obtaining a third query similarity measure relating said query object to a third database member that said column similarity measure relates to; and wherein step d further comprises repeating step e after step c.

3. The method of claim 1 wherein said similarity measure comprises one of a Levenshtein distance, an Euclidean distance, a Needleman algorithm and a Wunsch algorithm.

4. The method of claim 1 wherein said similarity measure comprises an image edit distance.

5. A computer-readable medium, comprising instructions for:
a) providing a similarity matrix comprised of a plurality of similarity measures each of which relates a member of said database to itself or to another member of said set of reference objects;
b) obtaining a first query similarity measure relating a query object to a first reference object;
c) examining a row of said similarity matrix corresponding to said first member of said database to obtain a row similarity measure closest to said first query similarity measure, and, if said row similarity measure relates said first database member to itself, identifying said query object as said first database member as long as said first query similarity is above a predetermined threshold, else obtaining a second query similarity measure relating said query object to a second database member that said row similarity measure relates to; and
d) repeating step c, appropriately incrementing said identifying numbers preceding said database members and said query similarity measures, until said row similarity measure relates said reference object to itself.

6. The computer-readable medium of claim 5 wherein said similarity measure comprises one of a Levenshtein distance, an Euclidean distance, a Needleman algorithm and a Wunsch algorithm.

7. The computer-readable medium of claim 5 wherein said similarity measure comprises an image edit distance.

8. A computing device comprising: a computer-readable medium comprising instructions for:
a) providing a similarity matrix comprised of a plurality of similarity measures each of which relates a member of said database to itself or to another member of said set of reference objects;
b) obtaining a first query similarity measure relating a query object to a first reference object;
c) examining a row of said similarity matrix corresponding to said first member of said database to obtain a row similarity measure closest to said first query similarity measure, and, if said row similarity measure relates said first database member to itself, identifying said query object as said first database member as long as said first query similarity is above a predetermined threshold, else obtaining a second query similarity measure relating said query object to a second database member that said row similarity measure relates to; and
d) repeating step c, appropriately incrementing said identifying numbers preceding said database members and said query similarity measures, until said row similarity measure relates said reference object to itself.

9. The computing device of claim 8 wherein said similarity measure comprises one of a Levenshtein distance, a Euclidean distance, a Needleman algorithm and a Wunsch algorithm.

10. The computing device of claim 8 wherein said similarity measure comprises an image edit distance.

11. An apparatus for rapidly identifying a member of a database, comprising:
means for providing a similarity matrix comprised of a plurality of similarity measures each of which relates a member of said database to itself or to another member of said set of reference objects;
means for obtaining a first query similarity measure relating a query object to a first reference object;
means for examining a row of said similarity matrix corresponding to said first member of said database to obtain a row similarity measure closest to said first query similarity measure, and, if said row similarity measure relates said first database member to itself, identifying said query object as said first database member as long as said first query similarity is above a predetermined threshold, else obtaining a second query similarity measure relating said query object to a second database member that said row similarity measure relates to; and
means for repeating said examining a row of said similarity matrix, with appropriately increments of said identifying numbers preceding said database members and said query similarity measures, until said row similarity measure relates said reference object to itself.

12. The apparatus of claim 11 wherein said similarity measure comprises one of a Levenshtein distance, an Euclidean distance, a Needleman algorithm and a Wunsch algorithm.

13. The apparatus of claim 11 wherein said similarity measure comprises an image edit distance.
